(19) United States
(12) Patent Application Publication
(10) Pub. No.: US 2019/0037261 A1
(43) Pub. Date: Jan. 31, 2019

(54) ELECTRONIC DEVICE, CONTROL METHOD THEREFOR, AND COMPUTER-READABLE RECORDING MEDIUM

(71) Applicant: SAMSUNG ELECTRONICS CO., LTD., Suwon-si (KR)

(72) Inventors: Ernesto Evgeniy SANCHES SHAYDA, Rubtsovsk (RU); Egor BULYCHEV, Moscow (RU); Evgeny KRYUKOV, Saint-Petersburg (RU); Philippe FAVRE, Ollon (CH); Min-suk SONG, Suwon-si (KR)

(73) Assignee: SAMSUNG ELECTRONICS CO., LTD., Suwon-si (KR)

(21) Appl. No.: 16/072,817

(22) PCT Filed: Jan. 25, 2017
(86) PCT No.: PCT/KR2017/000872

§ 371 Date: Jul. 25, 2018

(30) Foreign Application Priority Data
Jan. 25, 2016 (KR) 10-2016-0008608

(51) Int. Cl. H04N 21/258; H04N 21/25; H04N 21/2668

(52) U.S. Cl. CPC H04N 21/25883; H04N 21/2668; H04N 21/252; H04N 21/25891

(57) ABSTRACT

An electronic device comprises: a communicator for receiving population distribution data for at least one item among gender, age, and income from an external server and receiving user information composed of a plurality of items from each of a plurality of other electronic devices; and a processor for predicting unknown information by using a predictive model in which the unknown information is predicted by using a pre-stored variable parameter, for user information having the unknown information on a preset item in the received user information, generating population distribution data for the preset item by using the received user information and the predicted unknown information, comparing the generated population distribution data with the received population distribution data so as to calculate an error of the generated population distribution data, and changing the parameter of the predictive model on the basis of the calculated error so as to modify the predictive model.

### TECHNICAL FIELD

The present disclosure relates to an electronic device, a control method therefor, and a computer-readable recording medium, and more particularly, to an electronic device for predicting unknown information of a user, a control method therefor and a computer-readable recording medium.

### BACKGROUND ART

Technologies for providing personalized services based on a variety of information have been used in various fields. For example, there are technologies such as a content recommendation system based on a purchase pattern of a user. In addition to the above technologies, various recommendation technologies such as a technology for recommending content by learning behavior patterns of a user using a content item, a technology for recommending a media list according to a user who watches TV, a recommendation technology based on local information and a content use log of a user, and a recommendation technology based on social-network and profile filtering have been proposed.

However, these conventional recommendation technologies provide recommendation services using only static information or fragmentary information. That is, in order to provide the recommendation services, it is essential that a user directly provide user information which is used for the recommendation.

Further, there is a problem in that it is difficult to recommend appropriate content suitable for a user because the amount of provided user information is very small or incomplete and it is costly to collect the information.

Accordingly, there is a need for a technology for more accurate performing user profiling based on a small amount of user information.

### DISCLOSURE

### Technical Problem

The present disclosure provides an electronic device capable of more accurately predicting unknown information of a user using population distribution data, a control method therefor, and a computer-readable recording medium.

### Technical Solution

According to an aspect of the present disclosure, an electronic device includes: a communication unit for receiving population distribution data for at least one item among gender, age, and income from an external server and receiving user information composed of a plurality of items from each of a plurality of other electronic devices; and a processor for predicting unknown information by using a predictive model in which the unknown information is predicted by using a pre-stored variable parameter, for user information having the unknown information on a preset item in the received user information, generating population distribution data for the preset item by using the received user information and the predicted unknown information, comparing the generated population distribution data with the received population distribution data so as to calculate an error of the generated population distribution data, and changing the parameter of the predictive model on the basis of the calculated error so as to modify the predictive model.

The processor may search for content corresponding to a plurality of users, respectively, based on at least one of the received user information and the predicted unknown information, and control the communication unit to transmit the searched content to other electronic devices corresponding to the plurality of users, respectively.

The processor may predict the unknown information using the predictive model and then search for the content corresponding to each of the plurality of user information based on at least one of the received user information and the predicted unknown information.

The processor may generate user interface screens corresponding to a plurality of users, respectively, based on at least one of the received user information and the predicted unknown information, and control the communication unit to transmit the generated user interface screens to other electronic devices corresponding to the plurality of users, respectively.

The processor may generate the population distribution data on the preset item using the received user information, the predicted unknown information, and a kernel probability density estimation method.

The processor may change the parameter so that a value of the generated population distribution data approximates a value of the received population distribution data to modify the predictive model.

The processor may extract the population distribution data on the preset item from the received population distribution data, and calculate the error of the generated population distribution data by comparing the generated population distribution data with the extracted population data.

The received user information composed of the plurality of items may be content use information in the plurality of other electronic devices and at least one of the gender, age, and income of the user input from the plurality of other electronic devices.

The processor may control the communication unit to transmit the predicted information to the plurality of other electronic devices, respectively.

The external server may be at least one of a public agency, a government, a market research institution, a survey agency, and a corporation.

According to another aspect of the present disclosure, a method for controlling an electronic device includes: receiving population distribution data for at least one item among gender, age, and income from an external server; receiving user information composed of a plurality of items from each of a plurality of other electronic devices; predicting unknown information by using a predictive model in which the unknown information on a preset item among the received user information is predicted by using a pre-stored variable parameter and the received user information; generating population distribution data on the preset item using the received user information and the predicted unknown information; calculating an error of the generated population distribution data by comparing the generated population distribution data with the received population distribution data; and changing the parameter of the predictive model on the basis of the calculated error so as to modify the predictive model.

The method may further include: searching for content corresponding to a plurality of users, respectively, based on at least one of the received user information and the predicted unknown information; and transmitting the searched content to other electronic devices corresponding to the plurality of users, respectively.

In the searching, the unknown information may be predicted using the predictive model and then the content corresponding to the plurality of user information, respectively, may be searched based on at least one of the received user information and the predicted unknown information.

The method may further include: generating user interface screens corresponding to a plurality of users, respectively, based on at least one of the received user information and the predicted unknown information; and transmitting the generated user interface screens to other electronic devices corresponding to the plurality of users, respectively.

In the generating of the population distribution data, the population distribution data on the preset item may be generated using the received user information, the predicted unknown information, and a kernel probability density estimation method.

In the modifying of the predictive model, the parameter may be changed so that a value of the generated population distribution data approximates a value of the received population distribution data to modify the predictive model.

The method may further include: extracting the population distribution data on the preset item from the received population distribution data, wherein in the calculating of the error, the error of the generated population distribution data is calculated by comparing the generated population distribution data with the extracted population distribution data.

In the receiving of the user information composed of the plurality of items, content use information in the plurality of other electronic devices and at least one of the gender, age, and income of the user input from the plurality of other electronic devices may be received.

The method may further include: transmitting the predicted information to the plurality of other electronic devices, respectively.

According to still another aspect of the present disclosure, a computer-readable recording medium includes a program for executing a method for controlling an electronic device, wherein the control method includes: receiving population distribution data for at least one item among gender, age, and income from an external server; receiving user information composed of a plurality of items from each of a plurality of other electronic devices; predicting unknown information by using a predictive model in which the unknown information on a preset item among the received user information is predicted by using a pre-stored variable parameter and the received user information; generating population distribution data on the preset item using the received user information and the predicted unknown information; calculating an error of the generated population distribution data by comparing the generated population distribution data with the received population distribution data; and changing the parameter of the predictive model on the basis of the calculated error so as to modify the predictive model.

### BRIEF DESCRIPTION OF THE DRAWINGS

FIG. 1 is a diagram illustrating a configuration of a user profiling system using an electronic device according to an exemplary embodiment of the present disclosure.

FIG. 2 is a block diagram illustrating a configuration of the electronic device according to the exemplary embodiment of the present disclosure.

FIG. 3 is a block diagram illustrating in detail the configuration of the electronic device according to the exemplary embodiment of the present disclosure.

FIG. 4 is a diagram schematically illustrating a user profiling method according to an exemplary embodiment of the present disclosure.

FIG. 5 is a diagram illustrating an example of a user interface screen provided to a user through another electronic device.

FIG. 6 is a flowchart illustrating the user profiling method according to the exemplary embodiment of the present disclosure.

FIG. 7 is a flowchart illustrating in detail a machine learning process according to an exemplary embodiment of the present disclosure.

FIGS. 8 to 11 are graphs illustrating results of the user profiling method according to the exemplary embodiment of the present disclosure.

### MODE FOR INVENTION

Hereinafter, exemplary embodiments of the present disclosure will be described in detail with reference to the accompanying drawings. In describing the present disclosure, if it is determined that the detail description of relevant known functions or components makes subject matters of the present disclosure obscure, the detailed description thereof will be omitted. In addition, the following exemplary embodiments may be changed in various forms, and therefore the technical scope of the present disclosure is not limited to the following exemplary embodiments. Rather, these exemplary embodiments are provided in order to make this disclosure more thorough and complete and completely transfer the technical ideas of the present disclosure to those skilled in the art.

In addition, unless explicitly described otherwise, ‘including’ any components will be understood to imply the inclusion of other components but not the exclusion of any other components. Further, various elements and areas in the drawings are schematically drawn. Therefore, the technical ideas of the present disclosure are not limited by a relative size or interval drawn in the accompanying drawings.

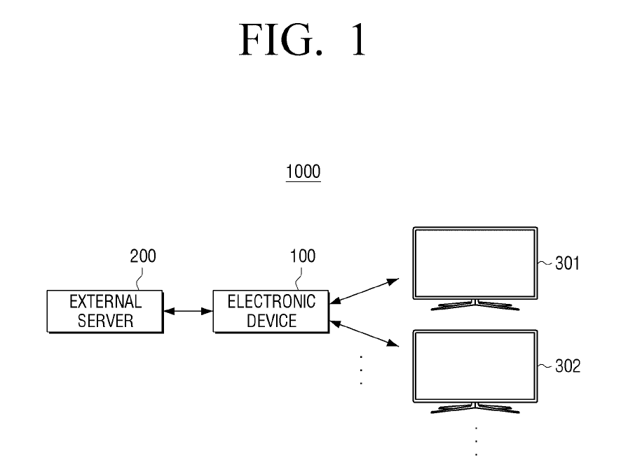

FIG. 1 is a diagram illustrating a configuration of a user profiling system using an electronic device according to an exemplary embodiment of the present disclosure.

Referring to FIG. 1, a user profiling system 100 according to an exemplary embodiment of the present disclosure includes an electronic device 100, an external server 200, and a plurality of other electronic devices 301 and 302.

In this case, the electronic device 100 can predict the unknown information of a user. Specifically, the electronic device 100 can predict the unknown information of the user based on population distribution data received from the external server 200 and user information received from the plurality of other electronic devices 301 and 302. In this case, the electronic device 100 can predict the unknown information of the user by using a predictive model that predicts the received user information and unknown information of the user.

In this case, the predictive model is a model that explains the relationship of dependent variables to independent variables or explains the relationship of outputs to inputs. The predictive model may be a black box model which is a model whose inputs, outputs, and functional performance are known, but whose internal implementation is unknown or irrelevant.

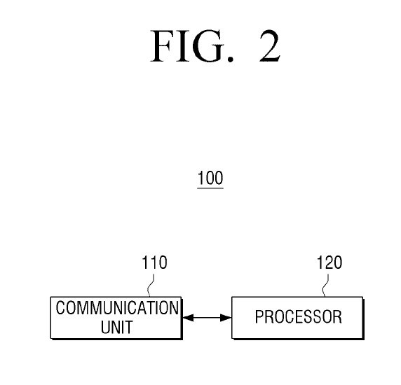

Meanwhile, a specific configuration of the electronic device 100 will be described below in detail with reference to FIG. 2.

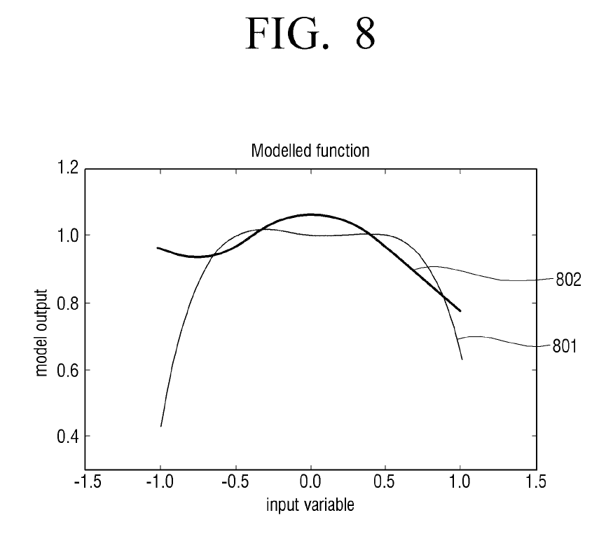

Meanwhile, the electronic device 100 can modify the predictive model using the predicted unknown information of the user. Specifically, the electronic device 100 can modify the predictive model by changing parameters of the predictive model. Meanwhile, a method for modifying a predictive model will be described in detail with reference to FIGS. 8 to 10.

In this case, the electronic device 100 may be a server which is connected to the external server 200 and other electronic devices 301 and 302, mobile devices such as a smart phone, a notebook and a tablet PC which are connected to the external server 200 and other electronic devices 301 and 302, and various display devices such as a smart TV and a desktop PC.

Meanwhile, the external server 200 provides population distribution data to the electronic device 100. In detail, the external server 200 may transmit the population distribution data for at least one item of gender, age, and income to the electronic device 100. Meanwhile, the external server 200 may provide the electronic device 100 with population distribution data on various items such as a residence area, an education level, and a household structure in addition to gender, age, and income.

In this case, the external server 200 may be at least one of a public agency, a government, a market research institution, a survey agency, and a corporation. Therefore, the population distribution data provided from the external server 200 may be open data or a predetermined cost may be required.

A plurality of other electronic devices 301 and 302 can transmit user information composed of a plurality of items to the electronic device 100. In this case, the plurality of other electronic devices 301 and 302 may be a device capable of receiving user information from a user, providing content selected by the user and the like. Specifically, the plurality of other electronic devices 301 and 302 may be various display devices such as a smart phone, a notebook, a desktop PC, a tablet PC, and a smart TV.

Specifically, the plurality of other electronic devices 301 and 302 may transmit user information including user log information and user account information from other electronic devices, respectively, to the electronic device 100.

In this case, the user log information may mean user behavior information of each of the plurality of other electronic devices 301 and 302. Specifically, the user log information may be the user behavior information including an electronic device use time, a favorite TV channel, a favorite TV program, a content purchase history, a service use history and the like.

Meanwhile, the user account information may be information that users of each of the plurality of other electronic devices 301 and 302 directly input to each electronic device. Specifically, the user account information may include user's personal information such as age, gender, income level, residence area, education level, and generation structure of a user.

FIG. 2 is a block diagram illustrating a configuration of the electronic device according to the exemplary embodiment of the present disclosure.

Referring to FIG. 2, the electronic device 100 according to the exemplary embodiment of the present disclosure includes a communication unit 110 and a processor 120.

The communication unit 110 may be connected to an external device through a wired Ethernet, a local area network (LAN), and an Internet network to connect an external server and a plurality of other electronic devices with the electronic device according to an exemplary embodiment of the present disclosure, and may use wireless communications (for example, wireless communications such as GSM, UMTS, LTE, WiBRO, WiFi, and Bluetooth).

Specifically, the communication unit 110 can receive population distribution data from the external server. Specifically, the communication unit 110 may receive population distribution data on at least one item of gender, age, and income from an external server. Meanwhile, the communication unit 110 can receive population distribution data on various items such as a residence area, an education level, and a household structure from the external server without being limited thereto.

Meanwhile, the communication unit 110 can receive user information composed of a plurality of items from a plurality of other electronic devices. Specifically, the communication unit 110 may receive, from each of a plurality of other electronic devices, user information which is composed of a plurality of items and includes user log information and user log information composed of a plurality of items.

In this case, the user log information may mean user behavior information of each of the plurality of other electronic devices which includes an electronic device use time, a favorite TV channel, a favorite TV program, a content purchase history, a service use history and the like.

Meanwhile, the user account information may mean information that users of each of the plurality of other electronic devices including a user's personal information such as age, gender, income level, residence area, education level, and generation structure input to each of the plurality of other electronic devices.

Meanwhile, the communication unit 110 may transmit the unknown information of the user predicted by the processor 120 to each of the plurality of other electronic devices. At this time, the communication unit 110 may transmit content and user interface screens corresponding to each user to each of the plurality of other electronic devices. Specifically, the communication unit 110 may transmit the content corresponding to each user searched by the processor 120 and the user interface screens generated by the processor 120 to the plurality of other electronic devices, respectively.

The processor 120 may control the communication unit 110 to receive data from the external server and the plurality of other electronic devices.

Meanwhile, the processor 120 can predict user information having unknown information on a preset item of the received user information by using user information received from the plurality of other electronic devices. Specifically, the processor 120 may predict the unknown information among the received user information using a predictive model predicting the unknown information and the received user information. In this case, the predictive model can predict the unknown information using pre-stored variable parameters.

Meanwhile, the processor 120 may generate the population distribution data on the preset item using the received user information and the predicted unknown information. Specifically, the processor 120 may generate the population distribution data on the preset item using probability density estimation.

In this case, the probability density estimation means estimating a probability density function of a certain variable and estimating a probability distribution characteristic of an original variable from the obtained data distribution.

Examples of the probability density estimation may include a parametric probability density estimation method and a non-parametric probability density estimation method. In this case, the parametric probability density estimation is a method for estimating only model parameters from data by setting a model for the probability density function in advance. However, in practice, the model is rarely given in advance, and therefore the probability density function should be estimated only by the obtained data, which is called the non-parametric probability density estimation method.

Specifically, examples of the non-parametric probability density estimation method may include a histogram method, a kernel probability density estimation method, a neural probability density estimation method, and the like. In this case, the histogram method is a method which obtains a histogram from the obtained data, normalizes the obtained histogram, and uses the normalized histogram as the probability density function. Meanwhile, the kernel probability density estimation method is a method which uses the kernel function. In this case, the kernel function is a non-negative function which is symmetry around an origin and has an integral value of 1, and typical examples of the kernel function may include a Gaussian function, Epanechnikov, uniform functions and the like.

For example, if x is a random variable, x1, x2, . . . , xn are the observed sample data, and K is the kernel function, in the kernel probability density estimation, the probability density function for x is estimated as follows.

$${\hat{f}}_{h} ( x ) = \frac{1}{n} {\sum }_{i = 1}^{n} {K}_{h} ( x - {x}_{i} ) = \frac{1}{nh} {\sum }_{i = 1}^{n} K ( \frac{( x - {x}_{i} )}{h} ) \qquad ( 1 )$$

In the above Equation (1), h is a bandwidth parameter of the kernel function, and is a parameter which controls whether the kernel has a sharp shape (h is a small value) or a smooth shape (h is a large value).

In the kernel probability density estimation, the type of the kernel function and the value of the bandwidth parameter h of the kernel function are important factors. It is known in the art that the optimal kernel function is the Epanechnikov kernel function.

Meanwhile, the processor 120 may modify the predictive model by changing the pre-stored variable parameters. Specifically, the processor 120 may generate the population distribution data on the preset item based on the probability density estimation using the received user inform on and the predicted unknown information, and modify the predictive model by changing the pre-stored parameters based on an error of the generated population distribution data.

In this case, the processor 120 may compare the generated population distribution data with the population distribution data received from the external server to change the pre-stored parameters based on the calculated error. Specifically, the processor 120 may extract the population distribution data on the preset item from the received population distribution data, and compares the extracted population distribution data with the generated population distribution data, to calculate the error of the generated population distribution data.

In this case, the processor 120 may compare the population distribution data generated based on a probability density similarity measure with the received population distribution data to calculate the error of the generated population distribution data. Specifically, the processor 120 may compare the generated population distribution data with the received population distribution data using Kullback-Leibler divergence.

For example, if the processor 120 receives population distribution data for age distribution of Korean males from the external server, the processor 120 extracts an age distribution of Korean males in their twenties from the received population distribution data, which may be used for the user profiling system according to exemplary embodiment of the present disclosure.

In this case, the Kullback-Leibler divergence is a function used to calculate the difference between two probability distributions, and for some ideal distributions a difference in information acquisition amount which may occur at the tame of performing the sampling by using different distributions which approximate the distributions may be calculated.

Meanwhile, the processor 120 may modify the predictive model by changing the pre-stored variable parameters based on the calculated error of the generated population distribution data. That is, the processor 120 is capable of machine learning based on the acquired data. In this case, the machine learning is the ability to acquire new information and efficiently use learned information, and is called a technology of analyzing and predicting data in a step forward form from a massive big data technology which is a data generation, a generation cycle, a generation format and the like. In addition, the machine learning may also include an improvement process for obtaining results by repeatedly performing an operation.

Specifically, the processor 120 may change the pre-stored variable parameters using an optimization method. In this case, the optimization method may mean finding a combination of parameters that optimize a function value of any objective function. Specifically, the optimization method is a principle that moves the parameter values to optimization parameter values little by little. Specifically, the parameter directions and the degree of movement are important factors, and the method for determining the same is a Newton method, a gradient descent method, a Levenberg-Marquardt method, a first order differentiation method, a second order differentiation method, a line search method, a trust region method, and a damping method.

For example, the processor 120 may change the pre-stored variable parameter so that the value of the generated population distribution data approximates the value of the population distribution data received from the external server having the optimized parameter.

Meanwhile, the processor 120 may control the communication unit 110 to transmit the predicted unknown information of the user to each of the plurality of other electronic devices. Meanwhile, the processor 120 controls the communication unit 110 to transmit the content corresponding to each user to each of the plurality of other electronic devices corresponding to the plurality of users based on the received user information and the predicted unknown information of the user. In this case, the content to be transmitted may be searched by the processor 120 based on the predicted unknown information of the user. In this case, the content to be transmitted may be a user-customized TV channel list, a TV program list, an advertisement, a movie and the like.

Meanwhile, the processor 120 may generate user interface screens corresponding to the plurality of users, respectively, based on at least one of the received user information and the predicted unknown information of the user. In this case, the user information and the plurality of recommendation content can be displayed on the generated user interface screens. Meanwhile, the processor 120 may control the communication unit 110 to transmit the generated unknown information of the user to other electronic devices corresponding to each of the plurality of other electronic devices.

As described in the present disclosure, it is possible to provide the electronic device capable of more accurately predicting the user information based on a small amount of data by repeatedly changing the parameters of the prediction model using the population distribution data received from the external server to modify the predictive model.

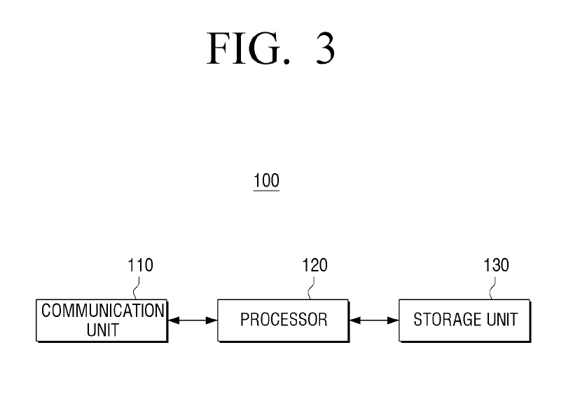

FIG. 3 is a block diagram illustrating in detail the configuration of the electronic device according to the exemplary embodiment of the present disclosure.

Referring to FIG. 3, the electronic device 100 according to the exemplary embodiment of the present disclosure includes a communication unit 110, a processor 120, and a storage unit 130. Although omitted for the sake of convenience in the above description, various configurations such as a display unit and an audio output unit may be included in the electronic device 100.

The communication unit 110 and the processor 120 are the same as those illustrated in FIG. 2, and the detailed description thereof will be omitted.

The storage unit 130 may store various programs and data required to operate the electronic device 100. In detail, the storage 130 may store a control program for controlling the electronic device 100, applications first provided from manufacturers or downloaded from the outside, a graphical user interface (hereinafter, referred to as GUI) associated with the applications, objects (for example, image text, icon, button, etc.) for providing the GUI, user information, document, databases, or related data.

Specifically, the storage unit 130 may store user information on a plurality of items received from the communication unit 110. In this case, the user information may include at least one of gender, age, income level, residence area, generation structure, device use information, service use information in a device, device use time, favorite channel, favorite TV program and the like of users of each of the plurality of other electronic devices.

The storage unit 130 may store parameters for predicting the unknown information among the received user information about the plurality of items.

The storage unit 130 may store the unknown user information predicted by the processor 120 using the stored parameters. In addition, the storage unit 130 may store the generated population distribution data on the preset item based on the received user information and the predicted unknown user information.

The storage unit 130 may store the changed parameter based on the error of the generated population distribution data.

Further, the storage unit 130 may store various types of content. Here, the content may be a video file such as an advertisement, a movie, or a TV program to be provided to a user from other electronic devices, or an image file such as a thumbnail image corresponding thereto, or the like.

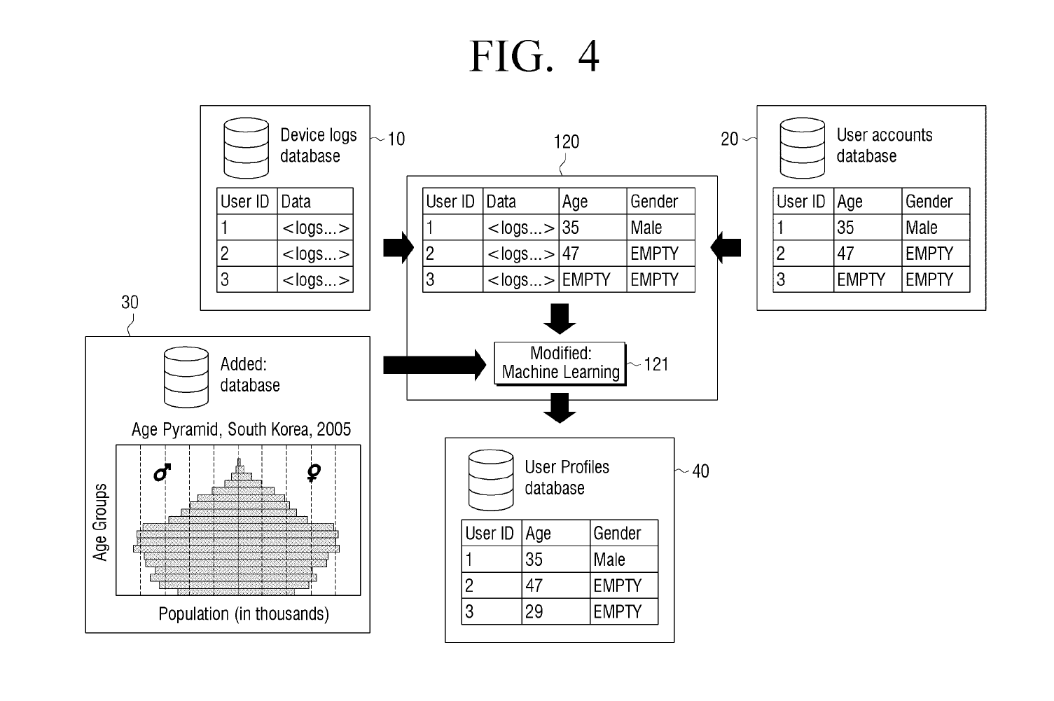

FIG. 4 is a diagram schematically illustrating a user profiling method according to an exemplary embodiment of the present disclosure.

Referring to FIG. 4, the processor 120 of the electronic device according to the exemplary embodiment of the present disclosure may use the user log information 10, user account information 20, and the population distribution data 30 to acquire result information 40 that is obtained by predicting the unknown information of the user based on a machine learning process 121.

First, the processor 120 may collect the user log information 10 and the user account information 20 to profile the user information. In this case, the user log information 10 and the user account information 20 may be received from the plurality of other electronic devices such as a smart TV or a mobile device used by each of the plurality of users.

In this case, the user account information 20 is information that a user directly inputs from other electronic devices, and unknown information may be included depending on whether the user inputs information. For example, since user 1 inputs both age and gender but user 2 inputs only the age, and user 3 does not input both gender and sex, the gender of the user 2 and the age and gender of the user 3 may correspond to unknown information.

In this case, the processor 120 may receive the population distribution data from the external server and obtain the result information 40 that is obtained by predicting the unknown information of the received user information. In this case, the processor 120 may more accurately acquire the result information through the machine learning process 121.

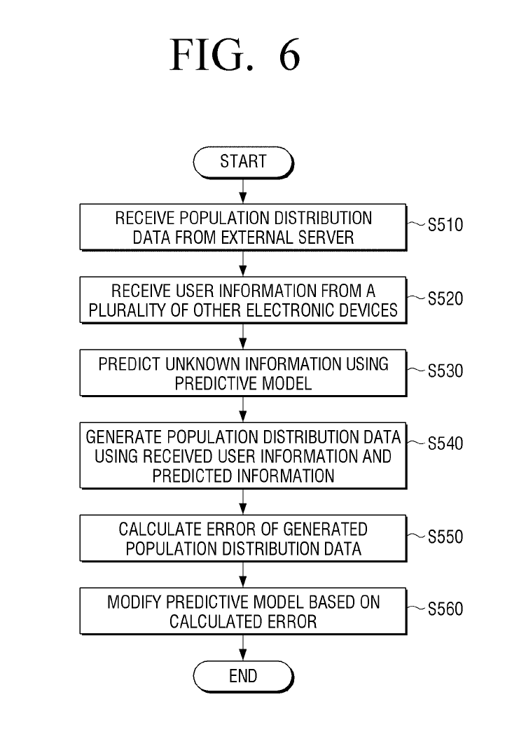

For example, the processor 120 may receive age distribution data according to the gender of citizens of Korean from an external server, and predict that the age of the user 3 is 29 years based on the predictive model. In this case, the processor 120 may more accurately acquire the age information through the machine learning process 121. On the other hand, the machine learning process 121 will be described below in detail with reference to FIGS. 6 to 8.

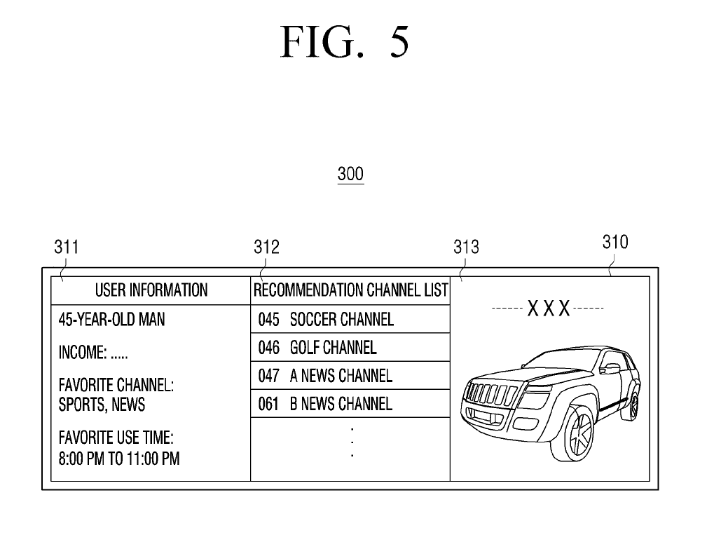

FIG. 5 is a diagram illustrating an example of a user interface screen provided to a user through another electronic device.

Referring to FIG. 5, another electronic device 300 may provide a user interface screen 310 through a display unit. In this case, the user interface screen 310 may include user information 311, a recommendation channel list 312 corresponding to user information, and a recommendation advertisement 313 corresponding to user information.

Meanwhile, the user interface screen 310 shown in FIG. 5 is merely an exemplary embodiment, and the present disclosure is not limited thereto, and the user interface screen 310 may not display the user information 311 including the unknown information of the user and may further include a recommendation TV program, a recommendation content and the like in addition to the recommendation channel list 312 and the recommendation advertisement 313.

In this case, the provided user interface screen 310 may receive the unknown information of the user predicted from the electronic device to generate the user interface information 310 that is generated by another electronic device 300 based on the previously input user information and the predicted unknown information, and the electronic device 300 may receive and display the user interface screen 310 generated based on the user information and the predicted unknown information of the user received from the other electronic device and the predicted unknown information of the user.

Meanwhile, for convenience of explanation, the user interface screen provided only on a smart TV is illustrated and described, but the user interface screen may be provided to mobile devices such as a smart phone in actual implementation.

It is possible to improve the convenience of the user's content selection by providing the content or the user interface screen corresponding to the user information by more accurately predicting the unknown information of the user using the population distribution data.

FIG. 6 is a flowchart illustrating the user profiling method according to the exemplary embodiment of the present disclosure.

Referring to FIG. 6, first, the electronic device receives the population distribution data from the external server (S510). In this case, the population distribution data may be open data provided by a public institution, a government and the like and may be provided by a market research organization, a survey agency, a corporation or the like to request a predetermined cost.

In this case, the population distribution data may be population distribution data for at least one item of gender, age, and income. Specifically, it may be population distribution data on a country or the whole city or the preset item. Meanwhile, the electronic device can extract the population distribution data on the preset item from the population distribution data received from the external server. For example, the electronic device can receive population distribution data for the entire age of the Korean population from the external server, and extract population distribution data according to the age of Korea in twenties.

Then, the electronic device can receive user information from a plurality of other electronic devices (S520). Specifically, the electronic device can receive user information which includes user log information including user behavior information at each of the other electronic devices from the plurality of other electronic devices, and user account information that the user directly inputs. Meanwhile, the user information received from the plurality of other electronic devices may include the unknown information of the user on the preset item. For example, referring to FIG. 3, any one item of user information composed of a plurality of items such as age, gender, and income of the user 1, which is a user of another electronic device, received from another electronic device, for example, the age of the user 3 may be the unknown information.

Next, the electronic device can predict the unknown information based on the predictive model (S530). Specifically, the electronic device may predict the unknown information of the user based on the predictive model that predicts the unknown information using the pre-stored variable parameters. In this case, the predictive model is a model that explains the relationship of dependent variables to independent variables or explains the relationship of outputs to inputs, which is referred to as a black box model which knows an input, and output, and a performance function but does not know the internal implementation thereof.

Next, the electronic device may generate population distribution data using the received user information and the predicted information (S540). Specifically, the electronic device may generate the population distribution data on the preset item using a probability density estimation method. In this case, the probability density estimation method may be any one of a histogram method, a kernel probability density estimation method, and a neural network probability density estimation method. The probability density estimation method is the same as that described in FIG. 2, and a detailed description thereof will be omitted.

For example, as shown in FIG. 3, the electronic device can use the age information of the received users 1 and 2, the age information of the predicted user 3, and the probability density estimation method to calculate the population distribution data according to the total population of Korea. Meanwhile, for convenience of explanation, it has been described that the population distribution data are generated using only the information of the users 1, 2 and 3. However, in actual implementation, the population distribution data may be generated by using more information of users.

Next, the electronic device may then calculate the error of the generated population distribution data (S550). Specifically, the electronic device can calculate the error of the population distribution data generated by comparing the generated population distribution data with the population distribution data received from the external server. In this case, the electronic device may calculate the error of the generated population distribution data based on a probability density similarity measurement such as the Kullback-Leibler divergence.

Next, the electronic device may modify the predictive model based on the calculated error (S560). Specifically, the electronic device may modify the predictive model by changing the pre-stored parameters based on the calculated error. Specifically, the electronic device can modify the predictive model by changing the pre-stored parameters so that the value of the population distribution data received from the external server having the optimized parameter coincides with the value of the generated population distribution data.

It is possible to perform the user profiling by more accurately predicting the user information based on a small amount of data by repeatedly changing the parameters of the predictive model using the population distribution data received from the external server to modify the predictive model.

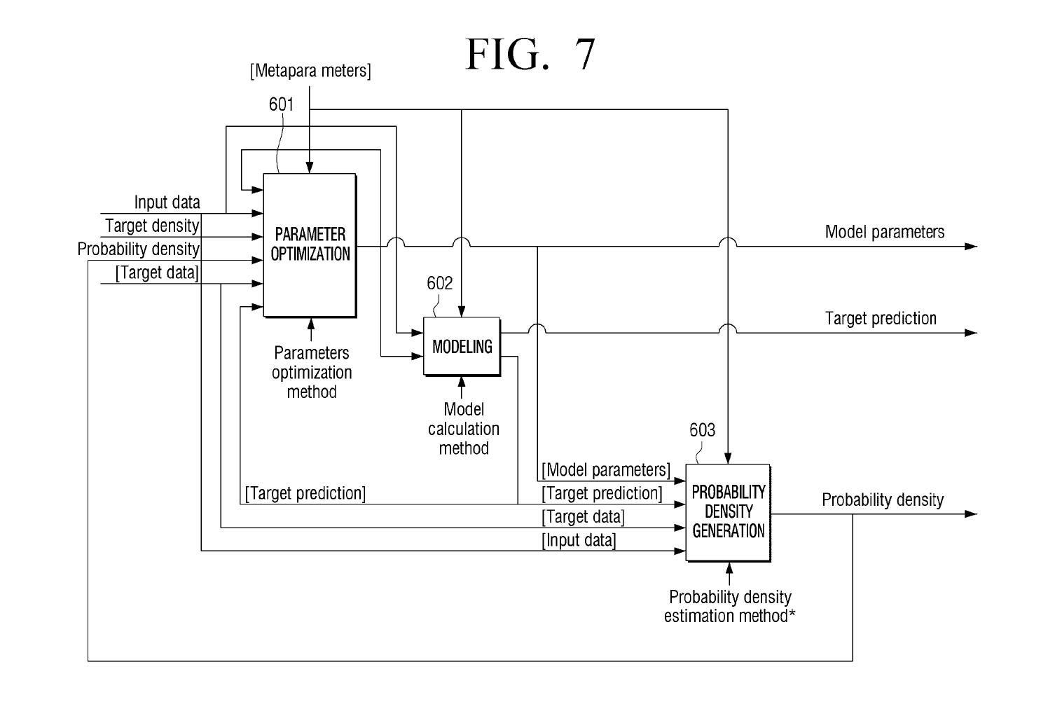

FIG. 7 is a flowchart illustrating in detail a machine learning process according to an exemplary embodiment of the present disclosure.

Referring to FIG. 7, the machine learning process according to an exemplary embodiment of the present disclosure includes a parameter optimization part 601, a modeling part 602 and a probability density generation part 603. The probability density of the present disclosure may mean the population distribution data.

Specifically, the parameter optimization part 601 may first pass the pre-stored parameters to the modeling part 602 at the beginning of the machine learning.

Meanwhile, the modeling part 602 receives input data and parameters from the parameter optimizing part 601, and may predict (perform a target prediction on) the unknown information on the preset item included in the input data. In this case, the input data may be the user behavior information and the user account information received from the plurality of other electronic devices, and the population distribution data received from the external server. In this case, the modeling part 602 may output the predicted unknown information, and transmit the predicted unknown information to the probability density generation part 603.

On the other hand, the probability density generation part 603 may generate the probability density on the preset item using the input data and the predicted unknown information transmitted from the modeling part 602. Specifically, the probability density generation part 603 can generate the probability density using the population distribution data received from the external server included in the input data.

Meanwhile, the probability density generation part 603 may output the probability density on the generated preset item and transmit the probability density to the parameter optimization part 601.

On the other hand, the parameter optimization part 601 can change the pre-stored parameters using the generated probability density received from the probability density generation part 603. Specifically, the parameter optimization part 601 compares the generated probability density received from the probability density generating part 603 with the population distribution data received from the external server included in the input data to change the pre-stored parameters so that the pre-stored parameters approximate the value of the population density data received from the external server having the optimized parameters.

On the other hand, the parameter optimization part 601 may transmit the changed parameters to the modeling part 602, so that the modeling part 602 can predict the unknown information using the changed parameter.

In this way, it is possible to perform the user profiling based on the more accurate user information prediction using a small amount of input data by optimizing the parameters through the machine learning process of repeatedly changing the parameters of the predictive model by comparing the probability density, which is generated by the predicted unknown information, with the population distribution data received from the external server.

FIG. 8 is a diagram illustrating a result of performing a user information prediction model according to a user profiling method according to the related art using a small amount of data.

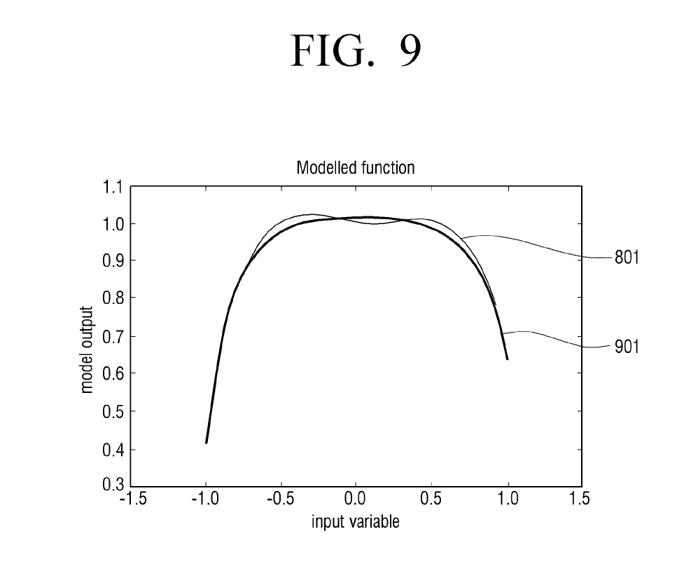

FIG. 9 is a diagram illustrating a result of performing a user information prediction model according to a user profiling method according to the present disclosure using a small amount of data.

Referring to FIGS. 8 and 9, if the predictive modeling according to the related art is performed using a small amount of data, there is a difference in an output function value 802 according to an input variable, a function type and a function value as compared with an actual function value 801, whereas the predictive modeling according to the exemplary embodiment of the present disclosure is performed, it may be confirmed that an output function value 901 according to an input variable substantially coincides with the actual function value 801. As a result, according to the exemplary embodiment of the present disclosure, it may be understood that the user information can be more accurately predicted even by using a small amount of data by repeatedly changing parameters using the population distribution data received from the external server.

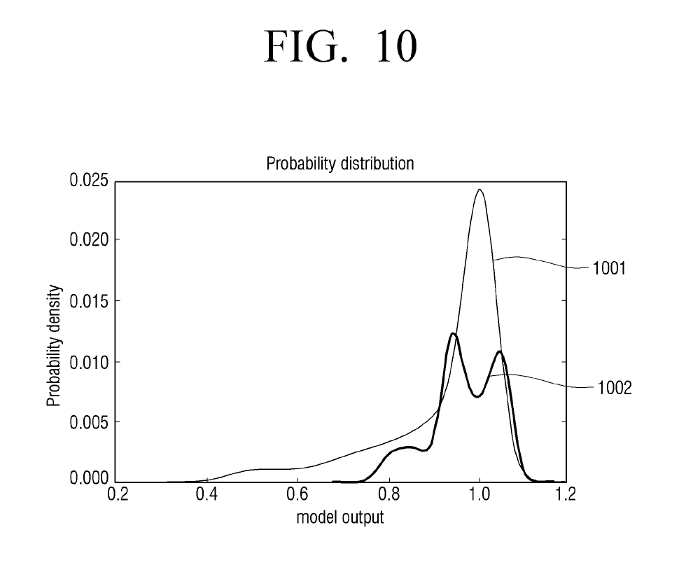

FIG. 10 is a diagram illustrating a probability density generated using predicted user information according to the related art using a small amount of data.

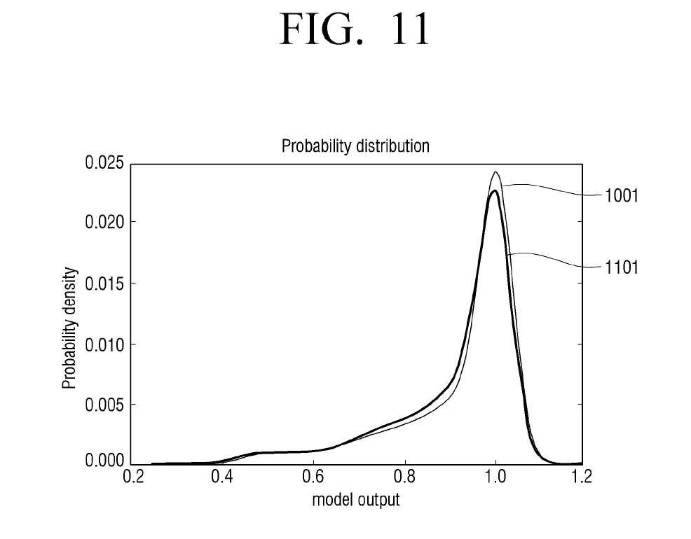

FIG. 11 is a diagram illustrating a generated probability density using user information predicted based on a user profiling method according to the present disclosure using a small amount of data.

Referring to FIGS. 10 and 11, a probability density 1002 generated using the predicted user information according to the related art using a small amount of data. 1002 has a difference in a probability density type and a probability density value according to the predicted user information (model output) as compared with a probability distribution 1001 based on the population distribution data received from the external server, whereas it may be confirmed that a probability density 1101 generated using the user information predicted by the user profiling method according to the exemplary embodiment of the present disclosure substantially coincides with the probability distribution 1001 based on the population distribution data received from the external server. As a result, according to the exemplary embodiment of the present disclosure, it may be understood that the user information can be more accurately predicted even by using a small amount of data by repeatedly changing the parameters using the population distribution data received from the external server.

As described above, according to various exemplary embodiments of the present disclosure, it is possible to perform the user profiling based on the more accurate user information prediction using a small amount of data by optimizing the parameters by repeatedly changing the parameters of the predictive model using the population distribution data received from the external server.

The methods according to the exemplary embodiment of the present disclosure may be implemented as a program instruction type that may be performed through various computer units and may be recorded in a computer-readable medium. The computer readable medium may include program instructions, data files, data structure, or the like, alone or a combination thereof. For example, the computer-readable medium may be stored in a volatile or non-volatile storage device such as a ROM, a memory such as a RAM, a memory chip, and a device or an integrated circuit, or a storage medium which may be read with a machine (for example, computer) simultaneously with being optically or magnetically recorded like a CD, a DVD, a magnetic disk, a magnetic tape, or the like, regardless of whether it is deleted or again recorded. The memory which may be included in a mobile terminal may be one example of a storage medium which may be read with programs including instructions implementing the exemplary embodiments of the present disclosure or a machine appropriate to store the programs. The program command recorded in the computer-readable recording medium may be designed and constituted especially for the present disclosure, or may be known to those skilled in a field of computer software.

Although the exemplary embodiments of the present disclosure have been disclosed for illustrative purposes, those skilled in the art will appreciate that various modifications, additions and substitutions are possible, without departing from the scope and spirit of the disclosure as disclosed in the accompanying claims.

Accordingly, the scope of the present disclosure is not construed as being limited to the described exemplary embodiments but is defined by the appended claims as well as equivalents thereto.

1. An electronic device, comprising:
a communication unit for receiving population distribution data for at least one item among gender, age, and income from an external server and receiving user information composed of a plurality of items from each of a plurality of other electronic devices; and
a processor for predicting unknown information by using a predictive model in which the unknown information is predicted by using a pre-stored variable parameter, for user information having the unknown information on a preset item in the received user information, generating population distribution data for the preset item by using the received user information and the predicted unknown information, comparing the generated population distribution data with the received population distribution data so as to calculate an error of the generated population distribution data, and changing the parameter of the predictive model on the basis of the calculated error so as to modify the predictive model.

2. The electronic device as claimed in claim 1, wherein the processor searches for content corresponding to a plurality of users, respectively, based on at least one of the received user information and the predicted unknown information, and controls the communication unit to transmit the searched content to other electronic devices corresponding to the plurality of users, respectively.

3. The electronic device as claimed in claim 2, wherein the processor predicts the unknown information using the predictive model and then searches for the content corresponding to each of the plurality of user information based on at least one of the received user information and the predicted unknown information.

4. The electronic device as claimed in claim 1, wherein the processor generates user interface screens corresponding to a plurality of users, respectively, based on at least one of the received user information and the predicted unknown information, and controls the communication unit to transmit the generated user interface screens to other electronic devices corresponding to the plurality of users, respectively.

5. The electronic device as claimed in claim 1, wherein the processor generates the population distribution data on the preset item using the received user information, the predicted unknown information, and a kernel probability density estimation method.

6. The electronic device as claimed in claim 1, wherein the processor changes the parameter so that a value of the generated population distribution data approximates a value of the received population distribution data to modify the predictive model.

7. The electronic device as claimed in claim 1, wherein the processor extracts the population distribution data on the preset item from the received population distribution data, and calculates the error of the generated population distribution data by comparing the generated population distribution data with the extracted population data.

8. The electronic device as claimed in claim 1, wherein the received user information composed of the plurality of items is content use information in the plurality of other electronic devices and at least one of the gender, age, and income of the user input from the plurality of other electronic devices.

9. The electronic device as claimed in claim 1, wherein the processor controls the communication unit to transmit the predicted information to the plurality of other electronic devices, respectively.

10. The electronic device as claimed in claim 1, wherein the external server is at least one of a public agency, a government, a market research institution, a survey agency, and a corporation.

11. A method for controlling an electronic device, comprising:
receiving population distribution data for at least one item among gender, age, and income from an external server;
receiving user information composed of a plurality of items from each of a plurality of other electronic devices;
predicting unknown information by using a predictive model in which the unknown information on a preset item among the received user information is predicted by using a pre-stored variable parameter and the received user information;
generating population distribution data on the preset item using the received user information and the predicted unknown information;
calculating an error of the generated population distribution data by comparing the generated population distribution data with the received population distribution data; and
changing the parameter of the predictive model on the basis of the calculated error so as to modify the predictive model.

12. The method as claimed in claim 11, further comprising:
searching for content corresponding to a plurality of users, respectively, based on at least one of the received user information and the predicted unknown information; and transmitting the searched content to other electronic devices corresponding to the plurality of users, respectively,
wherein in the searching, the unknown information is predicted using the predictive model and then the content corresponding to the plurality of user information, respectively, is searched based on at least one of the received user information and the predicted unknown information.

13. The method as claimed in claim 11, wherein in the generating of the population distribution data, the population distribution data on the preset item is generated using the received user information, the predicted unknown information, and a kernel probability density estimation method.

14. The method as claimed in claim 11, further comprising: extracting the population distribution data on the preset item from the received population distribution data, wherein in the calculating of the error, the error of the generated population distribution data is calculated by comparing the generated population distribution data with the extracted population distribution data.

15. The method as claimed in claim 11, wherein in the receiving of the user information composed of the plurality of items, content use information in the plurality of other electronic devices and at least one of the gender, age, and income of the user input from the plurality of other electronic devices are received.
